(19) United States
(12) Patent Application Publication
(10) Pub. No.: US 2026/0213428 A1
(43) Pub. Date: Jul. 23, 2026

(54) ANTENNA, FREQUENCY SELECTIVE SURFACE, VEHICLE, STRUCTURE AND METHOD

(71) Applicant: BAE Systems plc, London (GB)

(72) Inventor: Marek Sebastian Piechocinski, Filton, Bristol (GB)

(73) Assignee: BAE Systems plc, London (GB)

(21) Appl. No.: 19/137,810

(22) PCT Filed: Jan. 12, 2024
(86) PCT No.: PCT/GB2024/050036

§ 371 Date: Jun. 11, 2025

(30) Foreign Application Priority Data
Jan. 12, 2023 (EP) 23275008.3
Jan. 12, 2023 (GB) 2300452.6

(51) Int. Cl. H01Q 19/10; H01Q 21/00; H01Q 21/06

(52) U.S. Cl. CPC H01Q 19/10; H01Q 21/0087; H01Q 21/065

(57) ABSTRACT

According to the present disclosure there is provided an antenna comprising: an antenna element comprising: a magnetostrictive layer; and a piezoelectric layer, wherein the antenna further comprises a transducer arrangement comprising: one or more transducers operable to generate a mechanical strain field in the antenna element to produce displacement of the surface of the magnetostrictive layer.

### FIELD

The present invention relates to an antenna. More specifically, the present invention relates to an antenna comprising a transducer arrangement to produce displacement of the surface of a magnetostrictive layer of the antenna. A related frequency selective surface, vehicle, structure and method are also provided.

### BACKGROUND

A wireless communication system operating in a radio frequency range requires an antenna to convert an electromagnetic wave into an electrical current indicative of the received signal and vice versa. Selective control of electromagnetic (EM) waves received and/or transmitted by antenna is limited. Furthermore, a common problem with classical antenna is the effect of thermal losses.

Metasurface antennas are known. Metasurface antennas are designed to have particular signal receiving/transmission characteristics. However, they are typically limited in their adjustability. That is, metasurface antennas may be designed to receive or transmit EM waves of a particular frequency, with limited adjustment of said frequency or bandwidth.

Frequency selective surfaces are designed to reflect, transmit or absorb EM radiation of a particular frequency. However, they also have limited adjustability of the selected frequency. Furthermore, existing frequency selective surfaces have limited beam steering capabilities.

It is an example aim of example embodiments of the present invention to at least partially avoid or overcome one or more disadvantages of the prior art, whether identified herein or elsewhere, or to at least provide an alternative to existing antenna and methods.

### SUMMARY

According to a first aspect, there is provided an antenna comprising: an antenna element comprising: a magnetostrictive layer; and a piezoelectric layer, wherein the antenna further comprises a transducer arrangement comprising: one or more transducers operable to generate a mechanical strain field in the antenna element to produce displacement of the surface of the magnetostrictive layer.

In one example, in a receive mode, the magnetostrictive layer is configured to convert a magnetic field of a detected electromagnetic wave into mechanical strain, and the piezoelectric layer is configured to receive the mechanical strain from the magnetostrictive layer and produce a voltage and/or charge output based thereon.

In one example, in a transmit mode, the piezoelectric layer is configured to receive a voltage and/or charge input and produce mechanical strain based thereon, and the magnetostrictive layer is configured to receive the mechanical strain produced by the piezoelectric layer to produce and output an electromagnetic wave based thereon.

In one example, the antenna element is operable to detect an environmental characteristic in a region surrounding the antenna element, and the transducer arrangement is operable to generate mechanical strain field in the antenna element based on the environmental characteristic.

In one example, the piezoelectric layer comprises a memristive, memcapacitive or complex memimpedance characteristic.

In one example, the piezoelectric layer is arranged to be set to a defined non-volatile condition by application of a voltage and/or charge.

In one example, the piezoelectric layer is provided with electrical contacts to provide an electrical connection to driving circuitry.

In one example, the transducer arrangement comprises a plurality of transducers operable to generate a mechanical strain field interference pattern in the antenna element.

In one example, the transducer arrangement comprises one or more waveguides.

In one example, the antenna comprises an antenna element array comprising a plurality of antenna elements.

In one example, the antenna element array is a honeycomb antenna element array of hexagonal shape antenna elements.

In one example, one or more antenna elements are provided with one or more dedicated transducers.

In one example, one or more transducers of the transducer arrangement are operable to generate a mechanical strain field in a plurality of antenna elements.

In one example, the antenna further comprises one or more reflectors configured to reflect a mechanical strain wave generated by the one or more transducers. The one or more reflectors may be one or more acoustic reflectors.

According to a second aspect, there is provided a frequency selective surface comprising an antenna according to the first aspect.

In one example, the transducer arrangement is operable to tune the frequency selective surface.

According to a third aspect, there is provided a vehicle or structure comprising an antenna according to the first aspect or a frequency selective surface according to the second aspect.

According to a fourth aspect, there is provided a method of manufacturing an antenna, comprising providing: an antenna element comprising: a magnetostrictive layer; and a piezoelectric layer, and a transducer arrangement comprising: one or more transducers operable to generate a mechanical strain field in the antenna element to produce displacement of the surface of the magnetostrictive layer.

It will of course be appreciated that features described in relation to one aspect of the present invention may be incorporated into other aspects of the present invention. In particular, the method of the fourth aspect may comprise any or all of the features of the first to third aspects, as desired or as appropriate.

Other preferred and advantageous features of the invention will be apparent from the following description.

### BRIEF DESCRIPTION OF THE FIGURES

Embodiments of the invention will now be described by way of example only with reference to the figures, in which:

FIG. 1 shows an antenna;

FIG. 2 shows an antenna comprising an antenna element array; and

FIG. 3 shows a frequency selective surface;

FIG. 4 shows a vehicle;

FIG. 5 shows a structure; and

FIG. 6 shows general methodology principles.

### DETAILED DESCRIPTION

In overview, an antenna is provided with the ability to shape antenna surface geometry by generating a mechanical strain field in the antenna. The reception or transmission of electromagnetic (EM) waves using the antenna having a particular surface geometry generates a corresponding antenna radiation pattern.

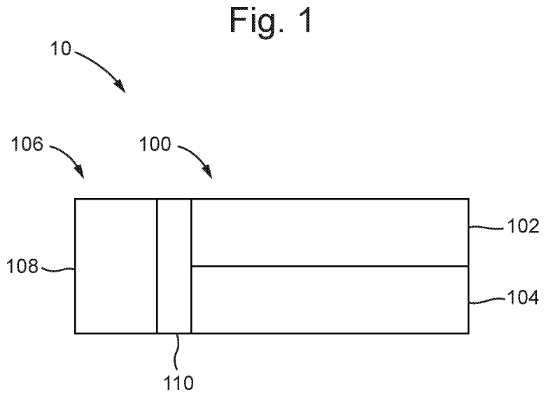

Referring to FIG. 1, an antenna 10 is shown. The antenna 10 comprises an antenna element 100. The antenna element 100 comprises a magnetostrictive layer 102 and a piezoelectric layer 104. The magnetostrictive layer 102 and piezoelectric layer 104 may be said to be “coupled”, as will be apparent from the description of the receiving and transmitting operations below.

The antenna 10 receives and transmits electromagnetic waves through the magnetoelectric effect at its acoustic resonance frequency. During a receiving operation of the antenna 10, the magnetostrictive layer 102 is configured to convert a magnetic field of a detected electromagnetic wave into mechanical strain, to be received by the piezoelectric layer 104. The piezoelectric layer 104 produces a voltage and/or charge output based on the strain received from the magnetostrictive layer 102. In detail, in receive mode, the magnetostrictive layer 102 may sense H-components of electromagnetic waves, which induce an oscillating strain transferred to the piezoelectric layer 104. The piezoelectric layer 104 may then produce a voltage and/or charge output.

Conversely, during a transmitting operation of the antenna 10, the piezoelectric layer 104 is configured to receive a voltage and/or charge input and produce mechanical strain based thereon. Such voltage and/or charge input may originate from the antenna 10 itself, or from an external component of an antenna system. Whilst not illustrated in the figures, the piezoelectric layer 104 may be provided with electrical contacts to provide an electrical connection to driving circuitry. The magnetostrictive layer 102 is configured to then receive the mechanical strain produced by the piezoelectric layer 104 to produce and output an electromagnetic wave based thereon. In detail, the piezoelectric layer 104 may receive an alternating voltage and/or charge input to produce an oscillating mechanical strain. In response to the mechanical excitation, the magnetostrictive layer 102 may then induce a magnetisation oscillation, or a magnetic current, that radiates electromagnetic waves to therefore transmit a signal.

Importantly, the antenna further comprises a transducer arrangement 106. The transducer arrangement 106 comprises one or more transducers 108. The one or more transducers 108 are operable to generate a mechanical strain field in the antenna element 100 to produce displacement of the surface of the magnetostrictive layer 102. The one or more transducers 108 may be surface acoustic wave resonators. The one or more transducers 108 may comprise on or more piezoelectric devices. The one or more transducers 108 may otherwise be referred to as “acoustic actuators”, operable to generate vibrations in the antenna element 100 by providing acoustic energy. Whilst it is noted that the transducers 108 are operable to generate a mechanical strain field to produce displacement of the magnetostrictive layer 102, it will be appreciated that displacement of the piezoelectric layer 104 will also occur.

Displacement of the surface of the magnetostrictive layer 102 due to the generation of the mechanical strain field by the one or more transducers 108 impacts the generation of, or response to, mechanical strain in the magnetostrictive layer 102. For the avoidance of doubt, the mechanical strain utilised to generate or receive electromagnetic waves is not the same as the mechanical strain field generated by the one or more transducers 108. It will be appreciated that magnetoelectric effect (i.e., in the receive mode or transmit mode) makes use of mechanical strain to receive and transmit electromagnetic waves using the antenna 10, but the present antenna 10 also advantageously makes use of a mechanical strain field produced by the one or more transducers 108 in order to control the antenna radiation pattern (i.e., to affect the mechanical strain in the receive mode or transmit mode). That is, the antenna 10 would still operate, making use of mechanical strain, in the absence of the one or more transducers 108, however the one or more transducers generate a mechanical strain field which impacts the response of the antenna 10 to the mechanical strain. This will be described in further detail herein.

As above, the one or more transducers 108 are operable to generate a mechanical strain field in the antenna element 100. The operation of the one or more transducers 108 vibrates the surface of the antenna element 100 to excite standing waves. This results in the generation of a surface pattern, or field, consisting of regions of relatively high (or higher) strain and regions of relatively low (or lower) strain. That is, a mechanical strain field is set up in the antenna element 100 comprising regions of high strain and regions of low strain in the magnetostrictive layer 102.

It follows that in the transmit mode, the regions of relatively high strain are difficult to excite whereas the regions of relatively low strain are easier to excite. Thus, when the magnetostrictive layer 102 receives the mechanical strain from the piezoelectric layer 104, the induced magnetisation oscillation in the high strain regions is lower in magnitude than the induced magnetisation oscillation in the low strain regions. In this way, an antenna radiation pattern is formed, consisting of regions of high electromagnetic wave emission and regions of low electromagnetic wave emission. It will be understood that the antenna radiation pattern can thereby be controlled by control of the mechanical strain field generated by the one or more transducers 108, for example by controlling or adjusting the magnitude or position of the regions of high and low strain.

Furthermore, it follows that in receive mode, the regions of relatively high strain are again difficult to excite, whereas the regions of relatively low strain are easier to excite. Thus, when the H-components of a detected electromagnetic wave induces an oscillating mechanical strain in the magnetostrictive layer 102, the magnetostrictive layer will exhibit a greater response in low strain regions of the magnetostrictive layer 102, and a lesser response in high strain regions of the magnetostrictive layer 102. In this way, by controlling or adjusting the magnitude or position of the regions of high and low strain, the antenna 10 can be tuned to receive (i.e., detect) specific frequencies of incoming electromagnetic waves.

The antenna element 100 illustrated in FIG. 1 comprises a stacked arrangement of a magnetostrictive layer 102 and a piezoelectric layer 104. In other examples, the antenna element 100 may comprise a plurality of magnetostrictive layers 102 and/or piezoelectric layers 104. In one advantageous example, the antenna element 100 may comprise a single magnetostrictive layer 102 located, or sandwiched, between two piezoelectric layers 104. In another advantageous example, the antenna element 100 may comprise multiple magnetostrictive layer 102 and piezoelectric layer 104 pairs provided on top of one another (i.e., a stack of alternating magnetostrictive and piezoelectric layers). Such arrangements advantageously result in the production of a greater signal magnitude, and hence greater device response in both the receive mode and transmit mode.

In an example, the piezoelectric layer 104 comprises a memristive, memcapacitive or complex memimpedance characteristic. The piezoelectric layer 104 may be formed of, or comprise, a material having said characteristic. The entire piezoelectric layer 104 may have said characteristic, or a region of the piezoelectric layer 104 may be formed having said characteristic. The piezoelectric layer 104 comprising said characteristic is arranged to be set to a non-volatile condition by application of a voltage and/or charge. Notably, the memristive material exhibits non-volatile memory characteristics and continuous conductance change property, therefore making it suitable for use in neuromorphic systems. A memristive material can be compared to a synapse in a brain.

The cellular mechanism that underlies learning and memory in human and animal brains is called long-term potentiation (LTP). LTP is a persistent strengthening of synapses based on recent patterns of activity. These are patterns of synaptic activity that produce a long-lasting increase in signal transmission between two neurons. Short-term potentiation (STP) refers to a process in which synaptic transmission is transiently enhanced. In this manner, STP can be thought of as short-term memory. STP can change into LTP through the process of repeated impressions involving many biological changes.

In general terms, a memristor (i.e., a memristive device) is a two-terminal resistive switching device that can maintain its internal resistance states depending on the history of applied voltages/currents. The two terminals behave similarly to an axon and dendrite that connect pre-neurons and post-neurons of a synapse, with the conductance of the switching layers comparable to the weight of the synapse. By changing the conductance of the memristor to a set state, the device can be used to realise the memorisation function of the human brain, by simulating the change from an unmemorised state to the STP and LTP states.

The piezoelectric layer 104 may be set to a defined condition by application of a voltage. Setting the piezoelectric layer 104 to the defined condition may comprise varying a conductance of the piezoelectric layer 104 by application of the voltage or charge. In particular, by applying a voltage to the piezoelectric layer 104, the resistance, conductance, or complex impedance of the memristive material comprised in the piezoelectric layer 104 can be modified, thereby realising the memorisation function described above. The voltage to be applied to the piezoelectric layer 104 may be an external bias voltage/charge, or an internal charge produced by the antenna 10 due to the piezoelectric effect.

The condition (or state) of the piezoelectric layer 104 may depend on the prior state, amplitude of the applied voltage, and acquisition time of the voltage/signal. For example, after application of a first voltage, the condition of the piezoelectric layer 104 may be changed from an initial state to a first state. If a second voltage is applied to the piezoelectric layer 104 after the first voltage has been applied, the condition of the piezoelectric layer 104 may be changed from the first state to a second state.

The resistance, conductance, or complex impedance of the piezoelectric layer 104 may be varied based on at least one of a frequency of the applied voltage and the polarity of the applied voltage. For example, by applying continuous positive voltage pulses, the conductance of the memristive material comprised in the piezoelectric layer 104 can be changed from an initial state to a higher state. Conversely, by applying negative voltage pulses, the conductance of the memristive material 104 can be changed from an initial state to a lower state. The conductance of the memristive material may also be changed by modifying a duration of the applied voltage.

The piezoelectric layer 104 may be configured to retain the set condition after the application of the voltage. As discussed above, a voltage may be applied in order to change the conductance of the memristive material comprised in the piezoelectric layer 104 can be changed from an initial state to a higher state. This change in conductance of the memristive material is retained for a period of time after the application of the voltage has ceased, thereby enabling the non-volatile memory operation of the memristive material. In other words, there is no need for a constant voltage application in order to vary the conductance of the memristive material in the piezoelectric layer 104. Varying the conductance/resistance of the memristive material comprised in the piezoelectric layer 104 may change a resonant frequency of the antenna 10.

The retention time can be defined as the amount of time during which the piezoelectric layer 104 will retain its set state, for example the amount of time during which the memristive material comprised in the piezoelectric layer 104 will retain its conductance at a changed state. The retention time may be increased by increasing at least one of the number of voltage pulses, pulse width and/or pulse magnitude.

The piezoelectric layer 104 may be arranged to be set to the defined condition prior to a receiving and/or transmitting operation of the antenna being performed. In such way, the antenna 10 may be pre-programmed or pre-set to the defined condition.

As discussed above, strain is generated by the magnetostrictive layer 102 by converting a magnetic field of a detected electromagnetic wave, i.e. the signal being detected by the antenna 10. The piezoelectric layer 104 may be configured to produce the voltage output based on a charge resulting from the received strain and the set condition of the piezoelectric layer 104. As such, the voltage output produced by the piezoelectric layer 104 may depend not only on the detected electromagnetic wave, but also on the set condition of the piezoelectric layer 104. For example, the voltage output may depend on the received strain, resulting from the detected electromagnetic wave, and the modified conductance of the memristive material comprised in the piezoelectric layer 104.

The piezoelectric layer 104 may be configured to produce the voltage output when a charge resulting from the received strain is equal to a threshold value defined based on the set condition of the piezoelectric layer. That is, the piezoelectric layer 104 may be configured to produce the voltage output only at the pre-programmed signal pattern acquisition. The piezoelectric layer 104 may be pre-programmed to respond to a specific signal pattern by employing the memory capabilities of the memristive material comprised therein. This can be realised by setting the piezoelectric layer 104 to the defined condition, corresponding to the signal pattern that a user wishes to detect.

In detail, the process of signal recognition by the memristive material comprised in the piezoelectric layer 104 may employ the switching nature of memristors. As discussed above, by application of a voltage, the resistance, conductance and complex impedance of the memristive material may be changed.

The transducer arrangement 108 comprises one or more waveguides 110. The one or more waveguides 110 are operable to control the propagation of the mechanical strain field. The operation of acoustic waveguides is well understood in the field of phononics. Said waveguides 110 may be referred to as “phononic crystal waveguides”. In the antenna 10, the waveguides 110 are operable to guide the input acoustic waves from the one or more transducers 108 into the antenna element 100. Advantageously, this facilitates control of the mechanical strain field propagation, as well as reducing loss of the energy input to the antenna element 100.

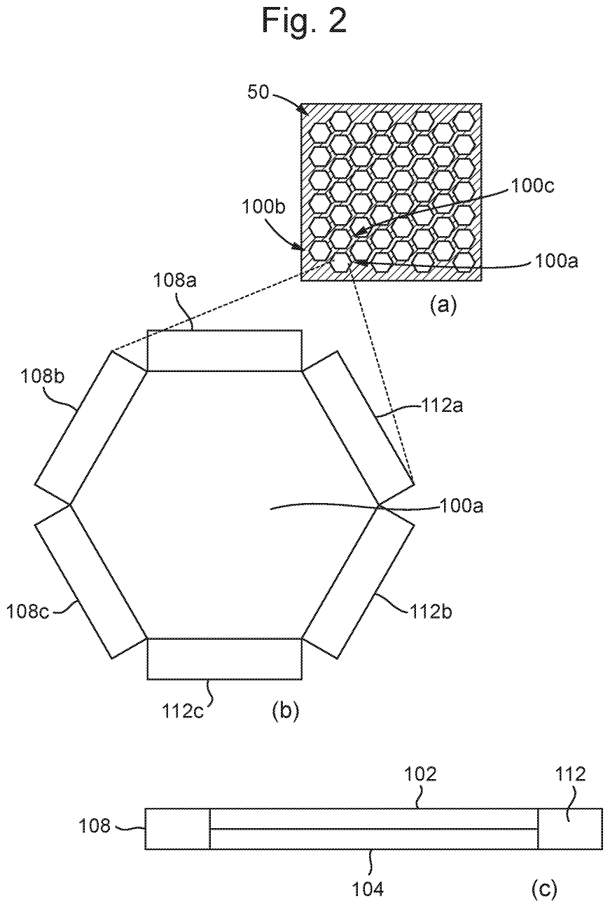

The antenna 10 illustrated in FIG. 1 and described above is shown and described only to comprise a single antenna element 100. However, the antenna 10 may comprise an antenna element array (or “antenna element matrix”) comprising a plurality of antenna elements. Such an arrangement is described below, with reference to FIG. 2. It will be appreciated that the operating principles of the antenna 10 will be understood from the above description, with further features explained with reference to FIG. 2.

Referring to FIG. 2(a), a plan view of the antenna 10 comprising an antenna element array 50 is shown. The antenna element array 50 comprises a plurality of antenna elements 100a, 100b, 100c, and so on. In the illustrated example, the antenna element array 50 comprises an array of laterally disposed antenna elements 100a, 100b, 100c (i.e., antenna elements arranged in a side-by-side manner). In another, non-illustrated, example, the antenna element array 50 comprises an array of vertically disposed antenna elements 100a, 100b, 100c (i.e., antenna elements arranged in a stacked or layered manner). In an example, the antenna element array 50 may comprise a combination of laterally and vertically disposed antenna elements. Providing the antenna element array 50 is highly advantageous for a number of reasons. Generating a mechanical strain field is more effective in smaller size antenna elements 100, which can be arranged to build up a larger size antenna 10. A further benefit is that the antenna 10 can be provided conformal to a platform surface, without antenna sensitivity to the surface geometry of said platform. That is, curvature or edges in the platform provided with the antenna 10 thereon will not impact operation of the antenna where the antenna 10 is formed of an array of (relatively small) antenna elements 100 arranged to form a larger antenna 10.

In this example, the antenna element array 50 is a honeycomb antenna element array of hexagonal shape antenna elements 100a, 100b, 100c. This shaping of antenna elements 100a, 100b, 100c in the antenna element array 50 is highly advantageous in packing of the elements in the array (i.e., providing an arrangement having a high density of antenna elements). Furthermore, the antenna 10 is not sensitive to the ground plane and proximity effects between antenna elements. Therefore, close packing of many antenna elements 100a, 100b, 100c is possible. Although hexagonal antenna elements provide the highest packing ratio, it will be appreciated that other antenna element shapes are of course possible, and indeed may be preferable or beneficial for operation of the antenna 10 (e.g., generating a desired antenna radiation pattern or receiving electromagnetic waves of a particular frequency).

Referring to FIGS. 2(b) and (c), an antenna element 100a of the antenna element array 50 is shown in isolation, in plan and side cross sectional views respectively. The magnetostrictive layer 102, piezoelectric layer 104, transducer 108 and a reflector 112 can be seen in FIG. 2(c). Whilst not illustrated in FIGS. 2(b) and (c), the transducer arrangement 106 also incorporates waveguides, as described above in relation to FIG. 1. A corresponding waveguide may be provided for each transducer.

A plurality of transducers 108a, 108b, 108c of the transducer arrangement 108 are shown in FIG. 2(b). The transducer arrangement 108, whilst present, is not illustrated in FIG. 2(a) for clarity.

The plurality of transducers 108a, 108b, 108c are operable to generate a mechanical strain field in the antenna element 100a. Furthermore, by the principles of constructive and destructive interference, the transducers 108a, 108b, 108c are operable to generate a mechanical strain field interference pattern in the antenna element 100a. In this way, regions of high strain (due to constructive interference) and regions of low strain (due to destructive interference) can be generated in the magnetostrictive layer 102.

As shown in FIG. 2(b), one or more reflectors 112a, 112b, 112c are also provided. The reflectors 112a-112c are configured to reflect a mechanical strain wave generated by the one or more transducers 108a-108c. In this way, the reflectors 112a-112c may function to generate constructive and destructive interference of acoustic waves (by reflecting the vibrations originating from the transducers), thereby to generate the mechanical strain field interference pattern in the antenna element 100a. Furthermore, reflectors 112a-112c are highly advantageous in that they may allow the number of transducers required to be reduced, thus reducing power consumption of the antenna 10.

In one example, one or more of the antenna elements 100a, 100b, 100c are provided with one or more dedicated transducers. A dedicated transducer may be a transducer which is arranged to generate a mechanical strain field in one particular antenna element. In this way, in addressing the antenna element 100a of the array 50, the dedicated transducer can be operated to generate a mechanical strain field in that particular antenna element 100a. The situation may be similar throughout the array, with each element 100a having one or more dedicated transducer. This is advantageous in simplifying addressing of antenna elements, and enhances control over the mechanical strain field generated.

In contrast, in another example, one or more transducers of the transducer arrangement 106 are operable to generate a mechanical strain field in a plurality of antenna elements (for example 100a, 100b). In a specific example, the transducer 108a may be operable to generate a mechanical strain field in antenna element 100a and neighbouring antenna element 100c. Furthermore, the transducer 108b may be operable to generate a mechanical strain field in antenna element 100a and neighbouring antenna element 100b. Advantageously, by this construction, greater control over the mechanical strain field propagation is provided. Additionally, and importantly, this simplifies construction and reduces power consumption, although a more complex scheme may be required to address certain antenna elements.

In a further non-illustrated example, an antenna arrangement may comprise two or more antenna 10 stacked vertically (i.e., on top of one another). Advantageously, this enables the possibility of having two or more beams serially aligned i.e., multiple focal points. Such an arrangement facilitates depth sensing for each antenna element stack.

In an exemplary application of the antenna 10, the antenna 10 may be operable to detect an environmental characteristic (or environmental condition) in a region surrounding the antenna element 100. The environmental characteristic may be a weather condition, air moisture content, or the like. The transducer arrangement 106 is operable to generate the mechanical strain field in the antenna element 100 based on the environmental characteristic. The transducer arrangement 106 may be operable to generate the mechanical strain field in the antenna element 100 to match a radar appearance of the region surrounding the antenna element 100. That is, the antenna 10 operates to match a radar appearance of the environment in which the antenna 10 is provided. The electromagnetic signature of the antenna 10 may be changed in real-time to provide low observability of the platform on which the antenna 10 is provided (such as a vehicle or structure), in both stationary and moveable conditions. Each antenna element 100 may perform this functionality, or alternatively the antenna 10 as a whole may do so.

Referring to FIG. 3, a frequency selective surface 300 is shown. The frequency selective surface 300 comprises the antenna 10. The transducer arrangement 106 is operable to tune the frequency selective surface 300. Highly advantageously, the antenna 10 can be used as, or in, a frequency selective surface, and overcomes problems with conventional frequency selective surfaces. In conventional frequency selective surfaces, fixedly formed apertures or patches are provided across a surface, acting as a bandpass or bandstop filter to a particular frequency of electromagnetic radiation. It will be understood that conventional frequency selective surfaces have defined and non-adjustable frequencies of interest. Instead, by the present construction, the antenna 10 enables broad bandwidth control, by the control and adjustment of the mechanical strain field by the transducer arrangement 106. Furthermore, the present construction provides for beam steering capability. That is, control of the surface geometry of the antenna 10 allows control of the array resonance, absorption, transmission and reflection properties of the antenna 10. Furthermore, controlled interaction with polarised electromagnetic signals is facilitated.

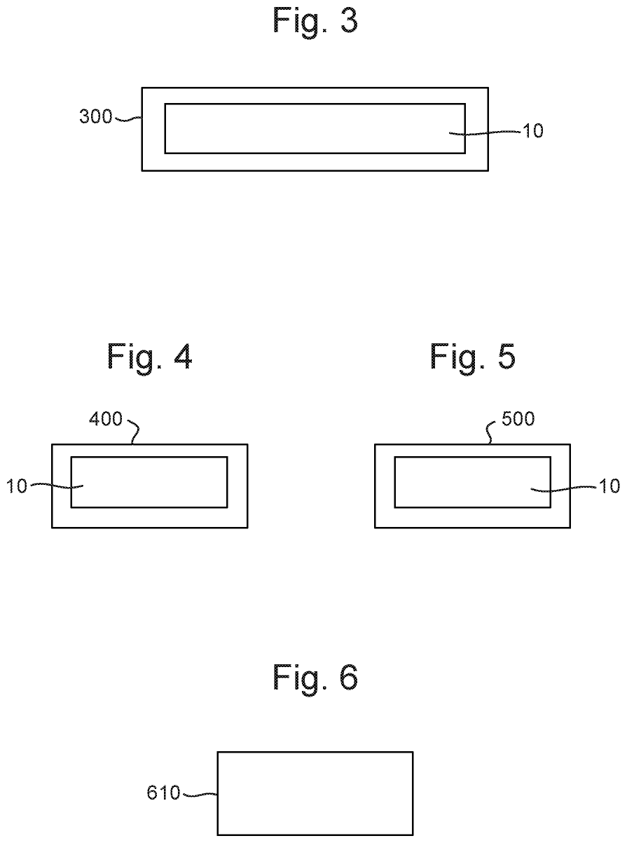

Referring to FIG. 4, a vehicle 400 is shown. The vehicle 400 comprises the antenna 10 or frequency selective surface 300. The antenna 10 or frequency selective surface 300 may be provided conformal to a surface of the vehicle 400. The vehicle 400 may be an aircraft, watercraft, space craft (such as a satellite), and/or a road-going vehicle.

Referring to FIG. 5, a structure 500 is shown. The structure 500 comprises the antenna 10 or frequency selective surface 300. The antenna or frequency selective surface 300 may be provided conformal to a surface of the structure 500. The structure 500 may be a building and/or a construction.

Referring to FIG. 6, a method of manufacturing an antenna 10 is shown. Step 610 comprises providing an antenna element comprising: a magnetostrictive layer; and a piezoelectric layer, and a transducer arrangement comprising: one or more transducers operable to generate a mechanical strain field in the antenna element to produce displacement of the surface of the magnetostrictive layer.

1. An antenna comprising:
an antenna element comprising:
a magnetostrictive layer; and
a piezoelectric layer,
wherein the antenna further comprises a transducer arrangement comprising:
one or more transducers operable to generate a mechanical strain field in the antenna element to produce displacement of the surface of the magnetostrictive layer.

2. The antenna according to claim 1, wherein, in a receive mode, the magnetostrictive layer is configured to convert a magnetic field of a detected electromagnetic wave into mechanical strain, and the piezoelectric layer is configured to receive the mechanical strain from the magnetostrictive layer and produce a voltage and/or charge output based thereon.

3. The antenna according to claim 1, wherein, in a transmit mode, the piezoelectric layer is configured to receive a voltage and/or charge input and produce mechanical strain based thereon, and the magnetostrictive layer is configured to receive the mechanical strain produced by the piezoelectric layer to produce and output an electromagnetic wave based thereon.

4. The antenna according to claim 3, wherein the antenna element is operable to detect an environmental characteristic in a region surrounding the antenna element, and the transducer arrangement is operable to generate the mechanical strain field in the antenna element based on the environmental characteristic.

5. : The antenna according to claim 1, wherein the piezoelectric layer comprises a memristive, memcapacitive or complex memimpedance characteristic, optionally wherein the piezoelectric layer is arranged to be set to a defined non-volatile condition by application of a voltage and/or charge.

6. The antenna according to claim 1, wherein the transducer arrangement comprises a plurality of transducers operable to generate a mechanical strain field interference pattern in the antenna element.

7. The antenna according to claim 1, wherein the transducer arrangement comprises one or more waveguides.

8. The antenna according to claim 1, comprising an antenna element array comprising a plurality of antenna elements.

9. The antenna according to claim 8, wherein the antenna element array is a honeycomb antenna element array of hexagonal shape antenna elements.

10. The antenna according to claim 8, wherein one or more antenna elements are provided with one or more dedicated transducers.

11. : The antenna according to claim 8, wherein one or more transducers of the transducer arrangement are operable to generate a mechanical strain field in a plurality of antenna elements.

12. The antenna according to claim 1, wherein the antenna further comprises one or more reflectors configured to reflect a mechanical strain wave generated by the one or more transducers.

13. A frequency selective surface comprising the antenna as claimed in claim 1, optionally wherein the transducer arrangement is operable to tune the frequency selective surface.

14. A vehicle or structure comprising the antenna according to claim 1.

15. A method of manufacturing an antenna, comprising providing: an antenna element comprising:
a magnetostrictive layer; and
a piezoelectric layer, and
a transducer arrangement comprising:
one or more transducers operable to generate a mechanical strain field in the antenna element to produce displacement of the surface of the magnetostrictive layer.
